(19) United States
(12) Patent Application Publication
(10) Pub. No.: US 2024/0002659 A1
(43) Pub. Date: Jan. 4, 2024

(54) THERMOPLASTIC COMPOSITION, METHOD FOR THE MANUFACTURE THEREOF, AND ARTICLES COMPRISING THE THERMOPLASTIC COMPOSITION

(71) Applicant: SHPP GLOBAL TECHNOLOGIES B.V., Bergen op Zoom (NL)

(72) Inventors: Haiming CHEN, Shanghai (CN); Christian LIETZAU, Selkirk, NY (US)

(21) Appl. No.: 18/038,331

(22) PCT Filed: Oct. 26, 2021
(86) PCT No.: PCT/IB2021/059894

§ 371 Date: May 23, 2023

(30) Foreign Application Priority Data
Dec. 4, 2020 (EP) 20211933.5

(51) Int. Cl. C08L 71/12; C08L 83/04

(52) U.S. Cl. CPC C08L 71/12; C08L 2203/20; C08L 2201/02; C08L 83/04

(57) ABSTRACT

A thermoplastic composition comprises particular amounts of a poly(phenylene ether)-poly(siloxane) block copolymer reaction product; a hydrogenated block copolymer of an alkenyl aromatic and a conjugated diene; tricalcium phosphate; and an organophosphate ester flame retardant. The composition can be particularly useful for use in battery pack insulation films or sheets.

### CROSS-REFERENCE TO RELATED APPLICATION

This application claims priority to and the benefit of European Patent Application No. 20211933.5, filed on Dec. 4, 2020, the contents of which are incorporated by reference herein in their entirety.

### BACKGROUND

Poly(arylene ether)s are commercially attractive materials because of their unique combination of properties, including, for example, high temperature resistance, dimensional and hydrolytic stability, and electrical properties, specifically comparative tracking index (CTI). The CTI value is a measure of the resistance of a material to form an electrically conductive path. Currently known poly(arylene ether) compositions have a CTI of 200 to 300 volts. However, some applications require a material having a high CTI in addition to the other desirable properties of poly(arylene ether).

Accordingly, there is a continuing need in the art for a poly(arylene ether) composition having a higher CTI. It would be further advantageous if, in addition to high CTI, the composition also exhibited high heat resistance, high impact strength, and low flammability.

### SUMMARY

A thermoplastic composition comprises 5 to 94 weight percent of a poly(phenylene ether)-poly(siloxane) block copolymer reaction product comprising a first poly(phenylene ether) and a poly(phenylene ether)-poly(siloxane) block copolymer; 0.5 to 15 weight percent of a hydrogenated block copolymer of an alkenyl aromatic and a conjugated diene; 0.5 to 10 weight percent of tricalcium phosphate; and 5 to 20 weight percent of an organophosphate ester flame retardant; wherein weight percent is based on the total weight of the composition.

A method of making the composition comprises melt-mixing the components of the composition.

An article comprises the composition.

A battery pack insulation film or sheet can be extruded from a composition comprising 5 to 94 weight percent of a poly(phenylene ether)-poly(siloxane) block copolymer reaction product comprising a first poly(phenylene ether) and a poly(phenylene ether)-poly(siloxane) block copolymer; 0.5 to 15 weight percent of a hydrogenated block copolymer of an alkenyl aromatic and a conjugated diene; 0.5 to 10 weight percent of tricalcium phosphate; and 5 to 20 weight percent of an organophosphate ester flame retardant; wherein weight percent is based on the total weight of the composition.

The above described and other features are exemplified by the following detailed description.

### DETAILED DESCRIPTION

The present inventor has unexpectedly discovered that a particular thermoplastic composition can provide a desirable combination of properties. More specifically, a composition which includes particular amounts of a poly(phenylene ether)-polysiloxane block copolymer reaction product, a hydrogenated block copolymer of an alkenyl aromatic and a conjugated diene, tricalcium phosphate, and an organophosphate ester flame retardant can provide a desirable combination of high CTI, high heat resistance, high impact strength, and low flammability. The present inventor has further unexpectedly discovered that such a composition can be particularly useful in battery pack insulation films or sheets, for example a battery pack insulation film or sheet for an electric vehicle extruded or molded from the composition.

Accordingly, an aspect of the present disclosure is a thermoplastic composition. The thermoplastic composition comprises a poly(phenylene ether)-polysiloxane block copolymer reaction product comprising a first poly(phenylene ether) and a poly(phenylene ether)-poly(siloxane) block copolymer. As used herein, the term “poly(phenylene ether)-polysiloxane block copolymer” refers to a block copolymer comprising at least one poly(phenylene ether) block and at least one polysiloxane block.

The poly(phenylene ether) block of the poly(phenylene ether)-poly(siloxane) block copolymer comprises repeating structural units having the formula

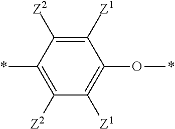

wherein each occurrence of Z¹ is independently halogen, unsubstituted or substituted C₁₋₁₂ hydrocarbyl provided that the hydrocarbyl group is not tertiary hydrocarbyl, C₁₋₁₂ hydrocarbylthio. C₁₋₁₂ hydrocarbyloxy, or C₂₋₁₂ halohydrocarbyloxy wherein at least two carbon atoms separate the halogen and oxygen atoms; and each occurrence of Z² is independently hydrogen, halogen, unsubstituted or substituted C₁₋₁₂ hydrocarbyl provided that the hydrocarbyl group is not tertiary hydrocarbyl, C₁₋₁₂ hydrocarbylthio, C₁₋₁₂ hydrocarbyloxy, or C₂₋₁₂ halohydrocarbyloxy wherein at least two carbon atoms separate the halogen and oxygen atoms. As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. As one example, Z¹ can be a di-n-butylaminomethyl group formed by reaction of a terminal 3,5-dimethyl-1,4-phenyl group with the di-n-butylamine component of an oxidative polymerization catalyst.

In an aspect, the poly(phenylene ether) block comprises 2,6-dimethyl-1,4-phenylene ether repeating units, that is, repeating units having the structure

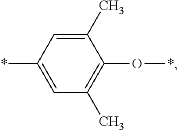

2,3,6-trimethyl-1,4-phenylene ether repeating units, or a combination thereof.

The poly(phenylene ether) can comprise molecules having aminoalkyl-containing end group(s), typically located in a position ortho to the hydroxy group. Also frequently present are tetramethyldiphenoquinone (TMDQ) end groups, typically obtained from 2,6-dimethylphenol-containing reaction mixtures in which tetramethyldiphenoquinone by-product is present. The poly(phenylene ether) can be in the form of a homopolymer, a copolymer, a graft copolymer, an ionomer, or a block copolymer, as well as combinations thereof.

The polysiloxane block is a residue of the hydroxyaryl-terminated polysiloxane. In an aspect, the polysiloxane block comprises repeating units having the structure

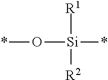

wherein each occurrence of R¹ and R² is independently hydrogen. C₁₋₁₂ hydrocarbyl or C₁₋₁₂ halohydrocarbyl; and the polysiloxane block further comprises a terminal unit having the structure

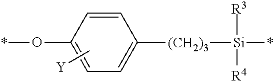

wherein Y is hydrogen, C₁₋₁₂ hydrocarbyl, C₁₋₁₂ hydrocarbyloxy, or halogen, and wherein each occurrence of R³ and R⁴ is independently hydrogen, C₁₋₁₂ hydrocarbyl or C₁₋₁₂ halohydrocarbyl. In an aspect, the polysiloxane repeating units comprise dimethylsiloxane (—Si(CH₃)₂O—) units. In an aspect, the polysiloxane block has the structure

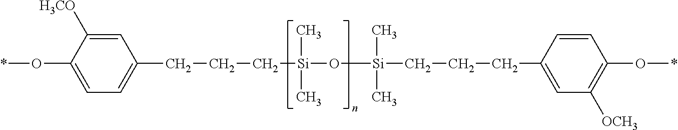

wherein n is, on average, 20 to 60.

The hydroxyaryl-terminated polysiloxane comprises at least one hydroxyaryl terminal group. In an aspect, the hydroxyaryl-terminated polysiloxane has a single hydroxyaryl terminal group, in which case a poly(phenylene ether)-polysiloxane diblock copolymer is formed. In an aspect, the hydroxyaryl-terminated polysiloxane has two hydroxyaryl terminal groups, in which case in which case poly(phenylene ether)-polysiloxane diblock copolymer and/or poly(phenylene ether)-polysiloxane-poly(phenylene ether) triblock copolymer are formed. It is also possible for the hydroxyaryl-terminated polysiloxane to have a branched structure that allows three or more hydroxyaryl terminal groups and the formation of corresponding branched block copolymers.

In an aspect, the hydroxyaryl-terminated polysiloxane comprises, on average, 20 to 80 siloxane repeating units, specifically 25 to 70 siloxane repeating units, more specifically 30 to 60 siloxane repeating units, still more specifically 35 to 50 siloxane repeating units, yet more specifically 40 to 50 siloxane repeating units. The number of siloxane repeating units in the polysiloxane block is essentially unaffected by the copolymerization and isolation conditions, and it is therefore equivalent to the number of siloxane repeating units in the hydroxyaryl-terminated polysiloxane starting material. When not otherwise known, the average number of siloxane repeating units per hydroxyaryl-terminated polysiloxane molecule can be determined by nuclear magnetic resonance (NMR) methods that compare the intensities of signals associated with the siloxane repeating units to those associated with the hydroxyaryl terminal groups. For example, when the hydroxyaryl-terminated polysiloxane is a eugenol-capped polydimethylsiloxane, it is possible to determine the average number of siloxane repeating units by a proton nuclear magnetic resonance (¹H NMR) method in which integrals for the protons of the dimethylsiloxane resonance and the protons of the eugenol methoxy group are compared.

In an aspect, the poly(phenylene ether)-polysiloxane block copolymer reaction product has a weight average molecular weight of at least 30,000 grams per mole (g/mol). For example, the reaction product can have a weight average molecular weight of 30,000 to 150,000 g/mol, specifically 35,000 to 120,000 g/mol, more specifically 40,000 to 90.000 g/mol, even more specifically 45,000 to 70,000 g/mol. In an aspect, the poly(phenylene ether)-polysiloxane block copolymer reaction product has a number average molecular weight of 10,000 to 50,000 g/mol, specifically 10,000 to 30.000 g/mol, more specifically 14,000 to 24,000 g/mol.

In an aspect, the poly(phenylene ether)-polysiloxane block copolymer reaction product has an intrinsic viscosity of at least 0.3 deciliter per gram, as measured by Ubbelohde viscometer at 25° C. in chloroform. In an aspect, the intrinsic viscosity is 0.3 to 0.5 deciliter per gram, specifically 0.31 to 0.5 deciliter per gram, more specifically 0.35 to 0.47 deciliter per gram.

The poly(phenylene ether)-polysiloxane block copolymer is prepared by an oxidative copolymerization method. In this method, the poly(phenylene ether)-polysiloxane block copolymer is the product of a process comprising oxidatively copolymerizing a monomer mixture comprising a monohydric phenol and a hydroxyaryl-terminated polysiloxane. In an aspect, the monomer mixture comprises 70 to 99 parts by weight of the monohydric phenol and 1 to 30 parts by weight of the hydroxyaryl-terminated polysiloxane, based on the total weight of the monohydric phenol and the hydroxyaryl-terminated polysiloxane. The hydroxyaryl-diterminated polysiloxane and monohydric phenol can be as described above.

The oxidative copolymerization method produces the poly(phenylene ether)-polysiloxane block copolymer as the desired product and poly(phenylene ether) (without an incorporated polysiloxane block) as a by-product. It is not necessary to separate the poly(phenylene ether) from the poly(phenylene ether)-polysiloxane block copolymer. The poly(phenylene ether)-polysiloxane block copolymer can thus be utilized as a “reaction product” that includes both the poly(phenylene ether) and the poly(phenylene ether)-polysiloxane block copolymer. Certain isolation procedures, such as precipitation from isopropanol, make it possible to assure that the reaction product is essentially free of residual hydroxyaryl-terminated polysiloxane starting material. In other words, these isolation procedures assure that the polysiloxane content of the reaction product is essentially all in the form of poly(phenylene ether)-polysiloxane block copolymer. Detailed methods for forming poly(phenylene ether)-polysiloxane block copolymers are described in U.S. Pat. Nos. 8,017,697 and 8,669,332 to Carrillo et al.

The poly(phenylene ether)-polysiloxane block copolymer reaction product can comprise 1 to 30 weight percent siloxane repeating units and 70 to about 99 weight percent phenylene ether repeating units, based on the total weight of the reaction product. It will be understood that the siloxane repeating units are derived from the hydroxyaryl-terminated polysiloxane, and the phenylene ether repeating units are derived from the monohydric phenol. In an aspect, such as, for example, when the poly(phenylene ether)-polysiloxane block copolymer reaction product is purified via precipitation in isopropanol, the siloxane repeating units consist essentially of the residue of hydroxyaryl-terminated polysiloxane that has been incorporated into the poly(phenylene ether)-polysiloxane block copolymer

In an aspect, the poly(phenylene ether)-polysiloxane block copolymer comprises phenylene ether repeating units derived from 2,6-dimethylphenol, 2,3,6-trimethylphenol, and combinations thereof. In an aspect, the poly(phenylene ether)-polysiloxane block copolymer can, for example, contribute 0.05 to 2 weight percent, specifically 0.1 to 1 weight percent, more specifically 0.2 to 0.8 weight percent, of siloxane groups to the composition as a whole.

The composition comprises the poly(phenylene ether)-polysiloxane block copolymer reaction product in an amount of 5 to 94 weight percent, based on the total weight of the composition. Within this range, the poly(phenylene ether)-polysiloxane block copolymer reaction product can be present in an amount of at least 8 weight percent, or at least 10 weight percent, or at least 12 weight percent, or at least 15 weight percent, or at least 20 weight percent, or at least 35 weight percent, or at least 50 weight percent, or at least 70 weight percent, or at least 75 weight percent. Also within this range, the poly(phenylene ether)-polysiloxane block copolymer reaction product can be present in an amount of less than or equal to 90 weight percent, or less than or equal to 75 weight percent, or less than or equal to 55 weight percent, or less than or equal to 40 weight percent, or less than or equal to 35 weight percent, or less than or equal to 30 weight percent. In an aspect, the poly(phenylene ether)-polysiloxane block copolymer reaction product can be present in an amount of 75 to 89.5 weight percent, or 75 to 85 weight percent. In an aspect, the poly(phenylene ether)-polysiloxane block copolymer reaction product can be present in an amount of 5 to 54.5 weight percent, or 5 to 50 weight percent, or 5 to 45 weight percent, or 5 to 40 weight percent, or 10 to 40 weight percent, or 10 to 35 weight percent, or 10 to 30 weight percent.

In addition to the poly(phenylene ether)-polysiloxane block copolymer reaction product, the thermoplastic composition can optionally further comprise a second poly(phenylene ether). The second poly(phenylene ether) can have an intrinsic viscosity of greater than 0.25 deciliters per gram, preferably 0.44 to 0.60 deciliters per gram, more preferably 0.44 to 0.50 deciliters per gram, measured at 25° C. in chloroform using an Ubbelohde viscometer. In an aspect, the second poly(phenylene ether) comprises a homopolymer or copolymer of the monomers 2,6-dimethylphenol, 2,3,6-trimethylphenol, and combinations thereof.

In an aspect, the composition comprises the second poly(phenylene ether), and the second poly(phenylene ether) has an intrinsic viscosity of greater than 0.43 deciliters per gram, preferably wherein the second poly(phenylene ether) comprises poly(2,6-dimethyl-1,4-phenylene ether).

When present, the composition comprises the poly(phenylene ether) in an amount of 35 to 75 weight percent, based on the total weight of the composition. Within this range, the second poly(phenylene ether) amount can be 40 to 75 weight percent, or 45 to 75 weight percent, or 50 to 75 weight percent, or 60 to 75 weight percent, or 40 to 70 weight percent, or 50 to 70 weight percent, or 60 to 70 weight percent. In an aspect, the second poly(phenylene ether) can be present in an amount of 35 to 70 weight percent.

In addition to the poly(phenylene ether)-poly(siloxane) block copolymer reaction product and, when present, the second poly(phenylene ether), the thermoplastic composition further comprises a hydrogenated block copolymer of an alkenyl aromatic and a conjugated diene.

For brevity, this component is referred to as the “hydrogenated block copolymer”. The hydrogenated block copolymer can comprise 10 to 90 weight percent of poly(alkenyl aromatic) content and 90 to 10 weight percent of hydrogenated poly(conjugated diene) content, based on the weight of the hydrogenated block copolymer. In an aspect, the hydrogenated block copolymer is a low poly(alkenyl aromatic content) hydrogenated block copolymer in which the poly(alkenyl aromatic) content is 10 to less than 40 weight percent, or 20 to 35 weight percent, or 25 to 35 weight percent, or 30 to 35 weight percent, all based on the weight of the low poly(alkenyl aromatic) content hydrogenated block copolymer. In an aspect, the hydrogenated block copolymer is a high poly(alkenyl aromatic content) hydrogenated block copolymer in which the poly(alkenyl aromatic) content is 40 to 90 weight percent, or 50 to 80 weight percent, or 60 to 70 weight percent, all based on the weight of the high poly(alkenyl aromatic content) hydrogenated block copolymer.

In an aspect, the hydrogenated block copolymer has a weight average molecular weight of 40,000 to 400,000 g/mol. The number average molecular weight and the weight average molecular weight can be determined by gel permeation chromatography and based on comparison to polystyrene standards. In an aspect, the hydrogenated block copolymer has a weight average molecular weight of 200,000 to 400,000 g/mol, or 220,000 to 350,000 g/mol. In an aspect, the hydrogenated block copolymer has a weight average molecular weight of 40,000 to 200,000 g/mol, or 40.000 to 180.000 g/mol, or 40,000 to 150,000 g/mol.

The alkenyl aromatic monomer used to prepare the hydrogenated block copolymer can have the structure

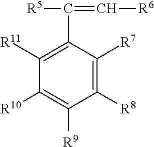

wherein R⁵ and R⁶ each independently represent a hydrogen atom, a C₁₋₈ alkyl group, or a C₂₋₈ alkenyl group; R⁷ and R¹¹ each independently represent a hydrogen atom, a C₁₋₈ alkyl group, a chlorine atom, or a bromine atom; and R⁸, R⁹, and R¹⁰ each independently represent a hydrogen atom, a C₁₋₈ alkyl group, or a C₂₋₈ alkenyl group, or R⁸ and R¹⁰ are taken together with the central aromatic ring to form a naphthyl group, or R⁹ and R¹⁰ are taken together with the central aromatic ring to form a naphthyl group. Specific alkenyl aromatic monomers include, for example, styrene, chlorostyrenes such as p-chlorostyrene, methylstyrenes such as alpha-methylstyrene and p-methylstyrene, and t-butylstyrenes such as 3-t-butylstyrene and 4-t-butylstyrene. In an aspect, the alkenyl aromatic monomer is styrene.

The conjugated diene used to prepare the hydrogenated block copolymer can be a C₄₋₂₀ conjugated diene. Suitable conjugated dienes include, for example, 1,3-butadiene, 2-methyl-1,3-butadiene, 2-chloro-1,3-butadiene, 2,3-dimethyl-1,3-butadiene, 1,3-pentadiene, 1,3-hexadiene, and the like, and combinations thereof. In an aspect, the conjugated diene is 1,3-butadiene, 2-methyl-1,3-butadiene, or a combination thereof. In an aspect, the conjugated diene is 1,3-butadiene.

The hydrogenated block copolymer is a copolymer comprising (A) at least one block derived from an alkenyl aromatic compound and (B) at least one block derived from a conjugated diene, in which the aliphatic unsaturated group content in the block (B) is at least partially reduced by hydrogenation. In an aspect, the aliphatic unsaturation in the (B) block is reduced by at least 50 percent, or at least 70 percent. The arrangement of blocks (A) and (B) includes a linear structure, a grafted structure, and a radial teleblock structure with or without a branched chain. Linear block copolymers include tapered linear structures and non-tapered linear structures. In an aspect, the hydrogenated block copolymer has a tapered linear structure. In an aspect, the hydrogenated block copolymer has a non-tapered linear structure. In an aspect, the hydrogenated block copolymer comprises a (B) block that comprises random incorporation of alkenyl aromatic monomer. Linear block copolymer structures include diblock (A-B block), triblock (A-B-A block or B-A-B block), tetrablock (A-B-A-B block), and pentablock (A-B-A-B-A block or B-A-B-A-B block) structures as well as linear structures containing 6 or more blocks in total of (A) and (B), wherein the molecular weight of each (A) block can be the same as or different from that of other (A) blocks, and the molecular weight of each (B) block can be the same as or different from that of other (B) blocks. In an aspect, the hydrogenated block copolymer is a diblock copolymer, a triblock copolymer, or a combination thereof.

In an aspect, the hydrogenated block copolymer excludes the residue of monomers other than the alkenyl aromatic compound and the conjugated diene. In an aspect, the hydrogenated block copolymer consists of blocks derived from the alkenyl aromatic compound and the conjugated diene. It does not comprise grafts formed from these or any other monomers. It also consists of carbon and hydrogen atoms and therefore excludes heteroatoms. In an aspect, the hydrogenated block copolymer includes the residue of one or more acid functionalizing agents, such as maleic anhydride. In an aspect, the hydrogenated block copolymer comprises a polystyrene-poly(ethylene-butylene)-polystyrene triblock copolymer.

In an aspect, the hydrogenated block copolymer is a polystyrene-poly(ethylene-butylene)-polystyrene triblock copolymer having a polystyrene content of 10 to 50 weight percent, or 20 to 40 weight percent, or 20 to 35 weight percent, or 25 to 35 weight percent, based on the weight of the polystyrene-poly(ethylene-butylene)-polystyrene triblock copolymer. In these aspects, the polystyrene-poly(ethylene-butylene)-polystyrene triblock copolymer can, optionally, have a weight average molecular weight of 200,000 to 400,000 grams per mole, or 250,000 to 350,000 grams per mole, determined by size exclusion chromatography using polystyrene standards.

Methods for preparing hydrogenated block copolymers are known in the art and many hydrogenated block copolymers are commercially available. Illustrative commercially available hydrogenated block copolymers include the polystyrene-poly(ethylene-propylene) diblock copolymers available from Kraton Performance Polymers Inc. as KRATON™ G1701 (having 37 weight percent polystyrene) and G1702 (having 28 weight percent polystyrene); the polystyrene-poly(ethylene-butylene)-polystyrene triblock copolymers available from Kraton Performance Polymers Inc. as KRATON™ G1641 (having 33 weight percent polystyrene). G1650 (having 30 weight percent polystyrene), G1651 (having 33 weight percent polystyrene), and G1654 (having 31 weight percent polystyrene); and the polystyrene-poly(ethylene-ethylene/propylene)-polystyrene triblock copolymers available from Kuraray as SEPTON™ S4044, S4055, S4077, and S4099. Additional commercially available hydrogenated block copolymers include polystyrene-poly(ethylene-butylene)-polystyrene (SEBS) triblock copolymers available from Dynasol as CALPRENE™ H6140 (having 31 weight percent polystyrene), H6170 (having 33 weight percent polystyrene), H6171 (having 33 weight percent polystyrene), and H6174 (having 33 weight percent polystyrene); and from Kuraray as SEPTON™ 8006 (having 33 weight percent polystyrene) and 8007 (having 30 weight percent polystyrene); polystyrene-poly(ethylene-propylene)-polystyrene (SEPS) copolymers available from Kuraray as SEPTON™ 2006 (having 35 weight percent polystyrene) and 2007 (having 30 weight percent polystyrene); and oil-extended compounds of these hydrogenated block copolymers available from Kraton Performance Polymers Inc. as KRATON™ G4609 (containing 45% mineral oil, and the SEBS having 33 weight percent polystyrene) and G4610 (containing 31% mineral oil, and the SEBS having 33 weight percent polystyrene); and from Asahi as TUFTEC™ H1272 (containing 36% oil, and the SEBS having 35 weight percent polystyrene). Mixtures of two of more hydrogenated block copolymers can be used. In an aspect, the hydrogenated block copolymer comprises a polystyrene poly(ethylene-butylene)-polystyrene triblock copolymer having a weight average molecular weight of at least 100,000 grams per mole, or 200,000 to 400,000 grams per mole.

The composition comprises the hydrogenated block copolymer in an amount of 0.5 to 15 weight percent, based on the total weight of the composition. Within this range, the hydrogenated block copolymer amount can be 1 to 10 weight percent, or 3 to 8 weight percent, or 5 to 10 weight percent, or 4 to 8 weight percent, or 5 to 7 weight percent.

In an aspect, the composition can optionally further comprise a homopolystyrene or a high impact polystyrene. As used herein, the term homopolystyrene refers to a homopolymer of styrene. Thus, the residue of any monomer other than styrene is excluded from the homopolystyrene. The homopolystyrene can be atactic, syndiotactic, or isotactic. In an aspect, the homopolystyrene can be atactic homopolystyrene. In an aspect, the homopolystyrene can have a melt volume flow rate of 1.5 to 5 cubic centimeters per 10 minutes, measured at 200° C. and 5-kilogram load according to ISO 1133. High impact polystyrene, also known as HIPS or rubber-modified polystyrene, can comprise 80 to 96 weight percent polystyrene, specifically 88 to 94 weight percent polystyrene; and 4 to 20 weight percent polybutadiene, specifically 6 to 12 weight percent polybutadiene, based on the weight of the rubber-modified polystyrene. In an aspect, the rubber-modified polystyrene has an effective gel content of 10 to 35 percent.

When present, the homopolystyrene or the high impact polystyrene can be present in an amount of greater than 0 to 15 weight percent, or 1 to 10 weight percent, based on the total weight of the composition.

In addition to the poly(phenylene ether)-poly(siloxane) block copolymer reaction product, the hydrogenated block copolymer, and, optionally, the second poly(phenylene ether), the thermoplastic composition further comprises tricalcium phosphate. Tricalcium phosphate (CAS Reg. No. 1306-06-5) has the chemical formula Ca₅(OH)(PO₄)₃ and is also known as hydroxyapatite, hydroxylapatite, tribasic calcium phosphate, pentacalcium hydroxyorthophosphate, and apatite. In an aspect, the tricalcium phosphate can have an average particle size of 10 nanometers to 100 micrometers. Within this range the average particle size can be greater than or equal to 25 nanometers, or greater than or equal to 50 nanometers, or greater than or equal to 100 nanometers, or greater than or equal to 250 nanometers, or greater than or equal to 500 nanometers, or greater than or equal to 1 micrometer, or greater than or equal to 2 micrometers. Also within this range the average particle size can be less than or equal to 75 micrometers, or less than or equal to 50 micrometers, or less than or equal to 25 micrometers, or less than or equal to 15 micrometers, or less than or equal to 10 micrometers, or less than or equal to 8 micrometers.

The thermoplastic composition comprises tricalcium phosphate in an amount of 0.5 to 10 weight percent based on the total weight of the composition. Within this range the amount of tricalcium phosphate can be 0.5 to 5 weight percent, or 0.5 to 3 weight percent, or 0.75 to 2.5 weight percent.

The composition further comprises an organophosphate ester flame retardant. Exemplary organophosphate ester compounds include phosphate esters comprising phenyl groups, substituted phenyl groups, or a combination of phenyl groups and substituted phenyl groups, bis-aryl phosphate esters based upon resorcinol such as, for example, resorcinol bis(diphenyl phosphate), as well as those based upon bisphenols such as, for example, bisphenol A bis(diphenyl phosphate). In an aspect, the organophosphate ester is selected from tris(alkylphenyl) phosphates (for example, CAS Reg. No. 89492-23-9 or CAS Reg. No. 78-33-1), resorcinol bis(diphenyl phosphate) (CAS Reg. No. 57583-54-7), bisphenol A bis(diphenyl phosphate) (CAS Reg. No. 181028-79-5), triphenyl phosphate (CAS Reg. No. 115-86-6), tris(isopropylphenyl) phosphates (for example, CAS Reg. No. 68937-41-7), t-butylphenyl diphenyl phosphates (CAS Reg. No. 56803-37-3), bis(t-butylphenyl) phenyl phosphates (CAS Reg. No. 65652-41-7), tris(t-butylphenyl) phosphates (CAS Reg. No. 78-33-1), and combinations thereof.

In an aspect the organophosphate ester comprises a bis-aryl phosphate having the formula

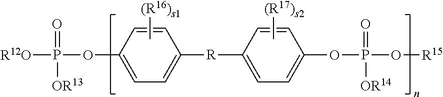

wherein R is independently at each occurrence a C₁₋₁₂ alkylene group; R¹⁶ and R¹⁷ are independently at each occurrence a C₁₋₅ alkyl group; R¹², R¹³, and R¹⁵ are independently a C₁₋₁₂ hydrocarbyl group; R¹⁴ is independently at each occurrence a C₁₋₁₂ hydrocarbyl group; n is 1 to 25; and s1 and s2 are independently an integer equal to 0, 1, or 2. In an aspect OR¹², OR¹³, OR¹⁴ and OR¹⁵ are independently derived from phenol, a monoalkylphenol, a dialkylphenol, or a trialkylphenol.

As readily appreciated by one of ordinary skill in the art, the bis-aryl phosphate is derived from a bisphenol. Exemplary bisphenols include 2,2-bis(4-hydroxyphenyl)propane (bisphenol A), 2,2-bis(4-hydroxy-3-methylphenyl)propane, bis(4-hydroxyphenyl)methane, bis(4-hydroxy-3,5-dimethylphenyl)methane and 1,1-bis(4-hydroxyphenyl)ethane. In an aspect, the bisphenol comprises bisphenol A.

In an aspect, the organophosphate ester comprises resorcinol bis-diphenyl phosphate, bis-phenol A bis-diphenyl phosphate, or a combination thereof.

The organophosphate ester can be present in the composition in an amount of 5 to 20 weight percent, based on the total weight of the composition. Within this range, the organophosphate ester can be present in an amount of 7 to 15 weight percent, or 8 to 14 weight percent, or 8.5 to 12.5 weight percent.

The thermoplastic composition can optionally further comprise an additive composition. The additive composition comprises one or more additives. The additives can be, for example, stabilizers, mold release agents, lubricants, processing aids, drip retardants, nucleating agents, UV blockers, dyes, pigments, antioxidants, anti-static agents, blowing agents, mineral oil, metal deactivators, antiblocking agents, or a combination thereof. In an aspect, the additive composition can comprise an antioxidant, a lubricant, a thermal stabilizer, an ultraviolet light absorbing additive, a plasticizer, an anti-dripping agent, a mold release agent, an antistatic agent, a dye, a pigment, a laser marking additive, a radiation stabilizer, or a combination thereof. When present, such additives are typically used in a total amount of 0.1 to 10 weight percent, based on the total weight of the composition.

The composition can optionally minimize or exclude additional components not specifically described herein. For example, the composition can comprise less than 2 weight percent, or less than 1 weight percent, or less than 0.5 weight percent, or less than 0.1 weight percent of any thermoplastic polymer other than the poly(phenylene ether)-poly(siloxane) block copolymer reaction product, the second poly(phenylene ether), the hydrogenated block copolymer, the polystyrene and the high-impact polystyrene. In an aspect, the composition can exclude any thermoplastic polymer other than the foregoing polymers of the present composition. In an aspect, the composition can minimize or exclude glass fibers. In an aspect, the composition can minimize or exclude homopolystyrene or rubber-modified polystyrene.

In an aspect, the composition can comprise the poly(phenylene ether)-polysiloxane block copolymer reaction product comprising a phenylene ether block comprising repeating units derived from 2,6-dimethyl phenol and a siloxane block comprising repeating units derived from dimethyl siloxane; the hydrogenated block copolymer of an alkenyl aromatic and a conjugated diene; the tricalcium phosphate; and the organophosphate ester flame retardant comprising resorcinol bis-diphenyl phosphate, bis-phenol A bis-diphenylphosphate, or a combination thereof. In an aspect, the composition can comprise 75 to 89.5 weight percent of the poly(phenylene ether)-poly(siloxane) block copolymer reaction product; 3 to 8 weight percent of the hydrogenated block copolymer of an alkenyl aromatic and a conjugated diene; 0.5 to 5 weight percent of tricalcium phosphate; and 7 to 15 weight percent of the organophosphate ester flame retardant comprising resorcinol bis-diphenyl phosphate, bis-phenol A bis-diphenyl phosphate, or a combination thereof.

In an aspect, the composition can comprise the poly(phenylene ether)-polysiloxane block copolymer reaction product comprising a phenylene ether block comprising repeating units derived from 2,6-dimethyl phenol and a siloxane block comprising repeating units derived from dimethyl siloxane; the hydrogenated block copolymer of an alkenyl aromatic and a conjugated diene; the tricalcium phosphate; the organophosphate ester flame retardant comprising resorcinol bis-diphenyl phosphate, bis-phenol A bis-diphenylphosphate, or a combination thereof, and the second poly(phenylene ether) comprising repeating units derived from 2,6-dimethyl phenol. In an aspect, the composition can comprise 5 to 54.5 weight percent of the poly(phenylene ether)-poly(siloxane) block copolymer reaction product; 35 to 70 weight percent of a second poly(phenylene ether); 3 to 10 weight percent of the hydrogenated block copolymer of an alkenyl aromatic and a conjugated diene; 0.5 to 5 weight percent of tricalcium phosphate; and 7 to 15 weight percent of the organophosphate ester flame retardant comprising resorcinol bis-diphenyl phosphate, bis-phenol A bis-diphenyl phosphate, or a combination thereof. In an aspect, the composition can comprise 10 to 45 weight percent of the poly(phenylene ether)-poly(siloxane) block copolymer reaction product; 45 to 70 weight percent of a second poly(phenylene ether); 3 to 10 weight percent of the hydrogenated block copolymer of an alkenyl aromatic and a conjugated diene; 0.5 to 5 weight percent of tricalcium phosphate; and 7 to 15 weight percent of the organophosphate ester flame retardant comprising resorcinol bis-diphenyl phosphate, bis-phenol A bis-diphenyl phosphate, or a combination thereof

The composition of the present disclosure can comprise 5 to 94 weight percent of a poly(phenylene ether)-poly(siloxane) block copolymer reaction product comprising a first poly(phenylene ether) and a poly(phenylene ether)-poly(siloxane) block copolymer; 0.5 to 15 weight percent of a hydrogenated block copolymer of an alkenyl aromatic and a conjugated diene; 0.5 to 10 weight percent of tricalcium phosphate; and 5 to 20 weight percent of an organophosphate ester flame retardant; wherein weight percent is based on the total weight of the composition. The composition can optionally further comprise 35 to 75 weight percent of a second poly(phenylene ether) having an intrinsic viscosity of greater than 0.25 deciliters per gram, preferably 0.44 to 0.60 deciliters per gram, more preferably 0.44 to 0.50 deciliters per gram, measured at 25° C. in chloroform using an Ubbelohde viscometer; preferably wherein the second poly(phenylene ether) comprises poly(2,6-dimethyl-1,4-phenylene ether). The hydrogenated block copolymer can comprise polystyrene-poly(ethylene-butylene)-polystyrene. The organophosphate ester flame retardant can comprise resorcinol bis-diphenyl phosphate, bis-phenol A bis-diphenylphosphate, resorcinol bis(di 2,6-dimethylphenyl) phosphate, oligomeric phosphate ester, triphenyl phosphate, or a combination thereof. The composition can comprise 0 to 15 weight percent of a homopolystyrene, or a high impact polystyrene. The composition can exclude glass fibers. The composition can further comprise 0.1 to 10 weight percent of an additive composition. The composition can comprise 75 to 89.5 weight percent of the poly(phenylene ether)-poly(siloxane) block copolymer reaction product; 3 to 8 weight percent of the hydrogenated block copolymer of an alkenyl aromatic and a conjugated diene; 0.5 to 5 weight percent of tricalcium phosphate; and 7 to 15 weight percent of the organophosphate ester flame retardant comprising resorcinol bis-diphenyl phosphate, bis-phenol A bis-diphenyl phosphate, or a combination thereof. The composition can comprise 5 to 54.5 weight percent of the poly(phenylene ether)-poly(siloxane) block copolymer reaction product; 35 to 70 weight percent of a second poly(phenylene ether); 3 to 10 weight percent of the hydrogenated block copolymer of an alkenyl aromatic and a conjugated diene; 0.5 to 5 weight percent of tricalcium phosphate; and 7 to 15 weight percent of the organophosphate ester flame retardant comprising resorcinol bis-diphenyl phosphate, bis-phenol A bis-diphenyl phosphate, or a combination thereof. The relative amount of each component can be adjusted within the ranges described above to provide the desired combination of properties. As is understood by one of skill in the art, the amount of each component is selected such that they total 100 weight percent.

The composition of the present disclosure can exhibit a desirable combination of physical properties. For example, a molded sample comprising the composition can exhibit a comparative tracking index of greater than or equal to 500 volts, preferably greater than or equal to 600 volts. A molded sample of the composition can exhibit a heat deflection temperature of greater than or equal to 105° C., measured on 3.2 mm thick bars using a load of 1.82 MPa according ASTM D648. A molded sample of the composition can exhibit a notched Izod impact strength of greater than or equal to 150 J/m, measured according to ASTM D256. A molded sample of the composition can exhibit one or more of: a UL-94 flammability rating of V0, measured using 1.0-millimeter test bars after conditioning at 23° C. for 48 hours and at 70° C. for 168 hours; or a UL-94 flammability rating of V0, measured using 0.75-millimeter test bars after conditioning at 23° C. for 48 hours and at 70° C. for 168 hours; or a UL-94 flammability rating of V0, measured using 0.5-millimeter test bars after conditioning at 23° C. for 48 hours and at 70° C. for 168 hours; or a UL-94 flammability rating of V0, measured using 0.3-millimeter test bars after conditioning at 23° C. for 48 hours and at 70° C. for 168 hours; a UL-94 flammability rating of V0, measured using 0.2-millimeter test bars after conditioning at 23° C. for 48 hours and at 70° C. for 168 hours; a UL-94 flammability rating of VTM0, measured using 0.125-millimeter test bars after conditioning at 23° C. for 48 hours and at 70° C. for 168 hours.

In an aspect, the composition can exhibit a combination of a particular UL-94 flammability rating, a particular comparative tracking index, a particular heat deflection temperature and a particular notched Izod impact strength. For example, the composition can exhibit: one or more of a UL-94 flammability rating of V0, measured using 1.0-millimeter test bars after conditioning at 23° C. for 48 hours and at 70° C. for 168 hours; or a UL-94 flammability rating of V0, measured using 0.75-millimeter test bars after conditioning at 23° C. for 48 hours and at 70° C. for 168 hours; or a UL-94 flammability rating of V0, measured using 0.5-millimeter test bars after conditioning at 23° C. for 48 hours and at 70° C. for 168 hours; or a UL-94 flammability rating of V0, measured using 0.3-millimeter test bars after conditioning at 23° C. for 48 hours and at 70° C. for 168 hours; a UL-94 flammability rating of V0, measured using 0.2-millimeter test bars after conditioning at 23° C. for 48 hours and at 70° C. for 168 hours; a UL-94 flammability rating of VTM0, measured using 0.125-millimeter test ban after conditioning at 23° C. for 48 hours and at 70° C. for 168 hours; and a comparative tracking index of greater than or equal to 500 volts, preferably greater than or equal to 600 volts; and a heat deflection temperature of greater than or equal to 105° C., measured according ASTM D648; and a notched Izod impact strength of greater than or equal to 150 J/m, measured according to ASTM D256.

The composition of the present disclosure can be manufactured, for example, by melt blending the components of the composition. The components of the composition can be mixed or blended using common equipment such as ribbon blenders. HENSCHEL™ mixers, BANBURY™ mixers, drum tumblers, and the like, and the blended composition can subsequently be melt-blended or melt-kneaded. The melt-blending or melt-kneading can be performed using common equipment such as single-screw extruders, twin-screw extruders, multi-screw extruders, co-kneaders, and the like. For example, the present composition can be prepared by melt-blending the components in a twin-screw extruder at a temperature of 270 to 310° C., or 280 to 300° C. The extrudate can be immediately quenched in a water bath and pelletized. The pellets so prepared can be one-fourth inch long or less as desired. Such pellets can be used for subsequent molding, shaping, or forming.

Shaped, formed, or molded articles comprising the composition represent another aspect of the present disclosure. The composition can be molded into useful shaped articles by a variety of methods, such as injection molding, extrusion, rotational molding, blow molding and thermoforming. Some examples of articles include an electric vehicle battery module, battery housing, battery case, battery cell frame, battery cell spacers, battery cell retainers, battery pack insulation film or sheet, bus bar holders, terminal covers, an electrical or electronic component, a thermoset circuit breaker, a fuser holder for an electrographic copier, a photovoltaic junction box, photovoltaic connector, an electrical connector, an automotive electrical connector, an electrical relay, a charge coupler, an appliance component, an automotive component, a portable device, a mobile component, or a stationary electrical component. In an aspect, the article is an extruded article, a molded article, pultruded article, a thermoformed article, a foamed article, a layer of a multi-layer article, a substrate for a coated article, or a substrate for a metallized article. In an aspect, the composition can be particularly useful in molded components for photovoltaic applications. For example, the composition can be used in a molded photovoltaic junction box. In an aspect, the composition of the present disclosure can be particularly useful for a battery pack insulation sheet or film, for example for use in an electric vehicle battery.

A battery insulation film or sheet represents another aspect of the present disclosure. The battery insulation film or sheet is molded or extruded from a composition comprising a poly(phenylene ether)-polysiloxane block copolymer reaction product, a hydrogenated block copolymer of an alkenyl aromatic and a conjugated diene, tricalcium phosphate, an organophosphate ester flame retardant, and optionally, a second poly(phenylene ether). Each component can be as described above. The composition can comprise 5 to 94 weight percent of a poly(phenylene ether)-poly(siloxane) block copolymer reaction product comprising a first poly(phenylene ether) and a poly(phenylene ether)-poly(siloxane) block copolymer; 0.5 to 15 weight percent of a hydrogenated block copolymer of an alkenyl aromatic and a conjugated diene; 0.5 to 10 weight percent of tricalcium phosphate; 5 to 20 weight percent of an organophosphate ester flame retardant; and optionally, 35 to 75 weight percent of a second poly(phenylene ether) having an intrinsic viscosity of greater than 0.25 deciliters per gram, preferably 0.44 to 0.60 deciliters per gram, more preferably 0.44 to 0.50 deciliters per gram, measured at 25° C. in chloroform using an Ubbelohde viscometer; wherein weight percent is based on the total weight of the composition.

In an aspect, the battery insulation film or sheet can be molded from a composition comprising 5 to 54.5 weight percent of the poly(phenylene ether)-poly(siloxane) block copolymer reaction product; 35 to 70 weight percent of the second poly(phenylene ether); 3 to 10 weight percent of the hydrogenated block copolymer of an alkenyl aromatic and a conjugated diene; 0.5 to 5 weight percent of tricalcium phosphate; and 7 to 15 weight percent of the organophosphate ester flame retardant comprising resorcinol bis-diphenyl phosphate, bis-phenol A bis-diphenyl phosphate, or a combination thereof. Advantageously, a molded sample of the composition (e.g., the photovoltaic junction box) exhibits: one or more of a UL-94 flammability rating of V0, measured using 1.0-millimeter test bars after conditioning at 23° C. for 48 hours and at 70° C. for 168 hours; or a UL-94 flammability rating of V0, measured using 0.75-millimeter test bars after conditioning at 23° C. for 48 hours and at 70° C. for 168 hours; or a UL-94 flammability rating of V0, measured using 0.5-millimeter test bars after conditioning at 23° C. for 48 hours and at 70° C. for 168 hours; or a UL-94 flammability rating of V0, measured using 0.3-millimeter test bars after conditioning at 23° C. for 48 hours and at 70° C. for 168 hours; a UL-94 flammability rating of V0, measured using 0.2-millimeter test bars after conditioning at 23° C. for 48 hours and at 70° C. for 168 hours; a UL-94 flammability rating of VTM0, measured using 0.125-millimeter test bars after conditioning at 23° C. for 48 hours and at 70° C. for 168 hours; and a comparative tracking index of greater than or equal to 500 volts, preferably greater than or equal to 600 volts; and a heat deflection temperature of greater than or equal to 105° C., measured according ASTM D648; and a notched Izod impact strength of greater than or equal to 150 J/m, measured according to ASTM D256.

As described herein, the present inventor has unexpectedly discovered that a composition including specific amounts of poly(phenylene ether)-polysiloxane block copolymer, a hydrogenated block copolymer of an alkenyl aromatic and a conjugated diene, tricalcium phosphate, an organophosphate ester flame retardant, and optionally, a second poly(phenylene ether) can provide certain advantageous properties. In particular, a combination of high CTI, high heat resistance, high impact strength, and low flammability, particularly for thin molded articles, can be obtained. Therefore, a significant improvement is provided by the present disclosure specifically as it relates to battery pack insulation film or sheet extruded from the composition.

This disclosure is further illustrated by the following examples, which are non-limiting.

### Examples

Materials used in the following examples are described in Table 1.

TABLE 1

| Component | Description | Supplier |
|---|---|---|
| PPE | Poly(2,6-dimethyl-1,4-phenylene ether) having an intrinsic viscosity of 0.46 | SABIC |
| | dl/g | |
| PPE-Si | A mixture of poly(2,6-dimethyl-1,4-phenylene ether) (CAS Reg. No. | SABIC |
| | 24938-67-8) and poly(2,6-dimethyl-1,4-phenylene ether- | |
| | polydimethylsiloxane block copolymer (CAS Reg. No. 1202019-56-4), the | |
| | mixture having a polysiloxane content of 5 weight percent and an intrinsic | |
| | viscosity of 0.40 deciliter per gram as measured in chloroform at 25° C.; | |
| | prepared according to the procedure of U.S. Pat. No. 8,017,697 to Carrillo | |
| | et al., Example 16. | |
| TCP | Tricalcium phosphate having an average particle size 10 um | Zhangjiagang |
| | | Taihua |
| | | Chemical Co., |
| | | Ltd |
| SEBS | Polystyrene-poly(ethylene-butylene)-polystyrene triblock copolymer, having | Kraton |
| | a polystyrene content of 30-33 weight percent and a negligible melt flow, | Performance |
| | measured at 260° C. and 5-kilogram load according to ASTM D1238; | Polymers, Inc. |
| | obtained as KRATON G1651 | |
| PS | Polystyrene having a melt flow rate of 9 g/10 min, obtained as STYRON | Trinseo LLC |
| | 680A | |
| HIPS | High-impact polystyrene (rubber-modified polystyrene), CAS Reg. No. 9003- | SABIC |
| | 55-8, having a volume average particle diameter of 2.4 micrometers, a rubber | |
| | content of 10 weight percent, a mineral oil content of 1.5 weight percent, and | |
| | a swell index of 17; obtained as HIPS 3190 | |
| BPADP | Bisphenol A bis-diphenyl phosphate, CAS Reg. No. 181028-79-5, obtained as | Zhejiang |
| | CR741 | Wansheng Co., |
| | | Ltd. |
| RDP | Resorcinol bis-diphenyl phosphate, CAS Reg. No. 57583-54-7 | Yoke |
| | | Technology |
| | | Co., Ltd |
| Phosphazene | Phenoxyphosphazene obtained as RABITLE FP-110T | Fushimi |
| | | Pharmaceutical |
| | | Co. Ltd. |
| TBPP | Tris(2,4-di-tert-butylphenyl) phosphite, CAS Reg. No. 31570-04-4; obtained | BASF |
| | as IRGAFOS ™ 168 | |
| ZnO | Zinc oxide, CAS Reg. No. 1314-13-2 | G H Chemical |
| | | Co., Ltd |
| ZnS | Zinc sulfide, CAS Reg. No. 1314-98-3; obtained Sachtolith HD-S | Taizhou ATS |
| | | Optical |
| | | Materials Co., |
| | | Ltd |
| TSAN | Poly(styrene-acrylonitrile)-encapsulated polytetrafluoroethylene, having a | SABIC |
| | polytetrafluoroethylene content of about 50 weight percent. | |

Compositions were compounded using a TEM-37BS compounder. All components were added at the feedthroat except BPADP or RDP, which were added downstream using a liquid injection system. The processing parameters used are summarized in Table 2.

TABLE 2

| Screw Design | L-2-1 | |
|---|---|---|
| Feed (Zone 0) Temp. | — | |
| Zone 1 Temp. | 50° | C. |
| Zone 2 Temp. | 150° | C. |
| Zone 3 Temp. | 240° | C. |
| Zone 4 Temp. | 280° | C. |
| Zone 5 Temp. | 280° | C. |
| Zone 6 Temp. | 280° | C. |
| Zone 7 Temp. | 300° | C. |
| Zone 8 Temp. | 300° | C. |
| Zone 9 Temp. | 300° | C. |
| Zone 10 Temp. | 280° | C. |
| Zone 11 Temp. | 280° | C. |
| Zone 12 Temp. | — | |
| Die Temp. | 290° | C. |
| Screw Speed | 300 | rpm |
| Throughput | 20 | kg/hr |
| Torque | 45% | |
| Side Feeder 1 speed | 250 | rpm |

Parts were molded using an UH1000-110 injection molding machine with temperature settings of 290-300-300-290° C. (from throat to nozzle) and a mold temperature of 75° C. Prior to molding the pellets were pre-dried at 110° C. for 2-4 hours.

Properties of the molded parts were tested according to the following standards.

Comparative Tracking Index (CTI) is used to measure the electrical breakdown (tracking) properties of an insulating material. Tracking is a measure of electrical breakdown on the surface of an insulating material. A large voltage difference gradually creates a conductive leakage path across the surface of the material by forming a carbonized track. The CTI testing procedure was carried out as described in ASTM D3638 test method. Briefly, the testing procedure involved adding 50 drops of a 0.1 wt % ammonium chloride solution dropwise to the surface of the material (3 mm thickness), followed by determination of the maximum voltage at which failure occurred. Based on the tracking index, the sample is assigned a Comparative Tracking Performance Level Category (PLC). Comparative Tracking Performance Level Categories are described in Table 3.

TABLE 3

| Tracking Index Range (volts) | PLC |
|---|---|
| 600 ≤ TI | 0 |
| 400 ≤ TI < 600 | 1 |
| 250 ≤ TI < 400 | 2 |
| 175 ≤ TI < 250 | 3 |
| 100 ≤ TI < 175 | 4 |
| 0 ≤ TI < 100 | 5 |

The heat deflection temperature (HDT) was determined in accordance with the ASTM D638 standard, using the flat side of 3.2 mm thick ASTM bars and a load of 1.82 MPa or 0.45 MPa (A/f).

Flame retardancy of injection molded flame bars was determined according to Underwriter's Laboratory Bulletin 94 “Tests for Flammability of Plastic Materials, UL 94”, 20 mm Vertical Burning Flame Test. Before testing, flame bars with a thickness of 1.5 millimeters were conditioned at 23° C. and 50% relative humidity for at least 48 hours or at 70° C. and 50% relative humidity for 168 hours. In the UL 94 20 mm Vertical Burning Flame Test, a set of ten to twenty flame bars was tested. For each bar, a flame was applied for 10 seconds to the bar then removed, and the time required for the bar to self-extinguish (first after flame time, t1) was noted. The flame was then reapplied for 10 seconds and removed, and the time required for the bar to self-extinguish (second after flame time, t2) and the post-flame glowing time (afterglow time, t3) were noted. To achieve a rating of V-0, the after flame times t1 and t2 for each individual specimen must have been less than or equal to 10 seconds; and the total after flame time for all five specimens (t1 plus t2 for all five specimens) must have been less than or equal to 50 seconds; and the second after flame time plus the afterglow time for each individual specimen (t2+t3) must have been less than or equal to 30 seconds; and no specimen can have flamed or glowed up to the holding clamp; and the cotton indicator cannot have been ignited by flaming particles or drops. To achieve a rating of V-1, the after flame times t1 and t2 for each individual specimen must have been less than or equal to 30 seconds; and the total after flame time for all five specimens (t1 plus t2 for all five specimens) must have been less than or equal to 250 seconds; and the second after flame time plus the afterglow time for each individual specimen (t2+t3) must have been less than or equal to 60 seconds; and no specimen can have flamed or glowed up to the holding clamp; and the cotton indicator cannot have been ignited by flaming particles or drops. To achieve a rating of V-2, the after flame times t1 and t2 for each individual specimen must have been less than or equal to 30 seconds; and the total after flame time for all five specimens (t1 plus t2 for all five specimens) must have been less than or equal to 250 seconds; and the second after flame time plus the afterglow time for each individual specimen (t2+t3) must have been less than or equal to 60 seconds; and no specimen can have flamed or glowed up to the holding clamp; but the cotton indicator can have been ignited by flaming particles or drops.

Notched Izod impact strength (NII), expressed in units of joules/meter, was measured according to ASTM D256 at 23° C. with a 5.5 Joule hammer and a 3.2-millimeter test bar.

Tensile properties were determined in accordance with ASTM D638. Tensile stress at break, expressed in units of megapascals (MPa), and tensile strain at break, expressed in units of percent, were measured at 23° C. using a test speed of 5 millimeters per minute.

Compositions and properties are summarized in Table 4. The amount of each component is provided in weight percent based on the total weight of the composition.

TABLE 4

| | Units | CE1 | CE2 | CE3 | CE4 | E1 | E2 | E3 | E4 |
|---|---|---|---|---|---|---|---|---|---|
| Component | | | | | | | | | |
| PPE | wt % | 81.20 | 80 | 75 | 67.4 | 68.95 | 63.95 | 58.95 | 53.4 |
| PPE-Si | wt % | | | | | 10 | 15 | 20 | 26.6 |
| TCP | wt % | | | | | 3 | 3 | 3 | 2 |
| SEBS | wt % | 6.2 | 6.2 | 6.2 | | 6.2 | 6.2 | 6.2 | 6.2 |
| PS | wt % | 2 | | | | | | | |
| HIPS | wt % | | | | 20.8 | | | | |
| BPADP | wt % | | 13 | 18 | 11 | 11 | 11 | 11 | 11 |
| RDP | wt % | 9.8 | | | | | | | |
| Phosphazene | wt % | | | | | | | | |
| TBPP | wt % | 0.5 | 0.5 | 0.5 | 0.5 | 0.5 | 0.5 | 0.5 | 0.5 |
| ZnO | wt % | 0.15 | 0.15 | 0.15 | 0.15 | 0.15 | 0.15 | 0.15 | 0.15 |
| ZnS | wt % | 0.15 | 0.15 | 0.15 | 0.15 | 0.15 | 0.15 | 0.15 | 0.15 |
| TSAN | wt % | | | | | 0.05 | 0.05 | 0.05 | |
| Properties | | | | | | | | | |
| CTI PLC | | 2 | 2 | 2 | 2 | 0 | 0 | 0 | 0 |
| HDT, 1.82 MPa | ° C. | 131 | 122 | 109 | 118 | 132 | 132 | 132 | 128 |
| HDT, 0.45 MPa | ° C. | 149 | 137 | 123 | 133 | 149 | 149 | 148 | 145 |
| UL94, 1.5 mm | | V0 | V0 | V0 | V0 | V0 | V0 | V0 | V0 |
| UL94, 1.0 mm | | V0 | V0 | V0 | V0 | V0 | V0 | V0 | V0 |
| UL94, 0.75 mm | | V1 | V0 | V0 | V0 | V0 | V0 | V0 | V0 |
| UL94, 0.5 mm | | V1 | V1 | V1 | V1 | V0 | V0 | V0 | V0 |
| UL94, 0.3 mm | | V1 | V1 | V1 | V1 | V0 | V0 | V0 | V0 |
| UL94, 0.2 mm | | V2 | V1 | V1 | V2 | V0 | V0 | V0 | V0 |
| UL94, 0.125 mm¹ | | — | — | — | — | VTM0 | VTM0 | VTM0 | VTM0 |
| NII, 23° C. | J/m | 202 | 235 | 176 | 140 | 157 | 181 | 156 | 202 |
| Tens. Elong. @ | % | 6 | 8.1 | 5.6 | 11.4 | 11.6 | 9.1 | 9.1 | 13.3 |
| Brk | | | | | | | | | |
| Tens. Elong. @ | % | 5 | 4.2 | 4 | 4.7 | 4.2 | 4.1 | 4.1 | 4.1 |
| Yield | | | | | | | | | |
| Tensile | MPa | 2505 | 2410 | 2490 | 2400 | 2570 | 2558 | 2562 | 2405 |
| Modulus | | | | | | | | | |
| Tens. Stress @ | MPa | 57 | 46.8 | 47 | 45.1 | 49 | 48 | 48 | 49 |
| Brk | | | | | | | | | |
| Tens. Stress @ | MPa | 72 | 65.1 | 65.3 | 63.2 | 65 | 64 | 64 | 62 |
| Yield | | | | | | | | | |
| | Units | E5 | E6 | E7 | E8 | E9 | E10 | E11 | E12 |
| Component | | | | | | | | | |
| PPE | wt % | 40 | | | | 62.95 | 61.95 | 52.95 | 51.95 |
| PPE-Si | wt % | 40 | 80 | 78 | 77 | 15 | 15 | 25 | 25 |
| TCP | wt % | 2 | 2 | 2 | 2 | 3 | 3 | 3 | 3 |
| SEBS | wt % | 6.2 | 6.2 | 6.2 | 6.2 | 7.2 | 8.2 | 7.2 | 8.2 |
| PS | wt % | | | | | | | | |
| HIPS | wt % | | | | | | | | |
| BPADP | wt % | 11 | 11 | 13 | 13 | 11 | 11 | 11 | 11 |
| RDP | wt % | | | | | | | | |
| Phosphazene | wt % | | | | 1 | | | | |
| TBPP | wt % | 0.5 | 0.5 | 0.5 | 0.5 | 0.5 | 0.5 | 0.5 | 0.5 |
| ZnO | wt % | 0.15 | 0.15 | 0.15 | 0.15 | 0.15 | 0.15 | 0.15 | 0.15 |
| ZnS | wt % | 0.15 | 0.15 | 0.15 | 0.15 | 0.15 | 0.15 | 0.15 | 0.15 |
| TSAN | wt % | | | | | 0.05 | 0.05 | 0.05 | 0.05 |
| Properties | | | | | | | | | |
| CTI PLC | | 1 | 2 | 2 | 2 | 0 | 0 | 0 | 0 |
| HDT. 1.82 MPa | ° C. | 125 | 118 | 111 | 109 | 136 | 137 | 132 | 132 |
| HDT, 0.45 MPa | ° C. | 143 | 135 | 128 | 126 | 152 | 153 | 149 | 148 |
| UL94, 1.5 mm | | V0 | V0 | V0 | V0 | V0 | V0 | V0 | V0 |
| UL94, 1.0 mm | | V0 | V0 | V0 | V0 | V0 | V0 | V0 | V0 |
| UL94, 0.75 mm | | V0 | V0 | V0 | V0 | V0 | V0 | V0 | V0 |
| UL94, 0.5 mm | | V0 | V0 | V0 | V0 | V0 | V0 | V0 | V0 |
| UL94, 0.3 mm | | V0 | V0 | V0 | V0 | V0 | V0 | V0 | V0 |
| UL94. 0.2 mm | | V0 | V0 | V0 | V0 | V0 | V0 | V0 | V0 |
| UL94, 0.125 mm¹ | | VTM0 | VTM0 | VTM0 | VTM0 | VTM0 | VTM0 | VTM0 | VTM0 |
| NII, 23° C. | J/m | 233 | 234 | 197 | 221 | 190 | 227 | 205 | 222 |
| Tens. Elong. @ | % | 10.5 | 9.1 | 8.6 | 9.4 | 17 | 29.5 | 13.1 | 12.3 |
| Brk | | | | | | | | | |
| Tens. Elong. @ | % | 4 | 3.8 | 3.7 | 3.7 | 4.1 | 4.1 | 4.0 | 4.0 |
| Yield | | | | | | | | | |
| Tensile | MPa | 2377 | 2317 | 2404 | 2350 | 2507 | 2448 | 2487 | 2435 |
| Modulus | | | | | | | | | |
| Tens. Stress @ | MPa | 47 | 46 | 44 | 44 | 49 | 49 | 48 | 46 |
| Brk | | | | | | | | | |
| Tens. Stress @ | MPa | 61 | 57 | 56 | 56 | 63 | 61 | 61 | 59 |
| Yield | | | | | | | | | |

¹“—” means the sample could not achieve VTM0

As shown in Table 4, the compositions of Examples 1-12 achieved the desired UL94 rating of V0 at thicknesses as low as 0.2 mm. At 0.125 mm, UL94 ratings of VTM0 (vertical thin material) were also achieved for each of Examples 1-12. In contrast, the compositions of the Comparative Examples did not exhibit UL94 ratings of V0 below 1.0 mm for CE1 or below 0.75 mm for CE2-4. Additionally, the compositions of Example 1-4 and 8-12 each achieved a CTI PLC rating of 0. The advantageous UL94 and CTI properties observed for the inventive examples were accompanied by little change in high temperature properties, impact strength, and tensile properties relative to the comparative examples. Thus, the specific compositions of Examples 1-12 generally demonstrate the ability to improve CTI and flame performance using a combination of TCP as an additive and PPE-Si as a flame retardant synergist without sacrificing other properties. For example, CTI and flame performance could be improved without affecting other properties (e.g., Notched Izod impact strength) such that the compositions would still be deemed sufficient for particular applications, for example in photovoltaic junction boxes. The advantageous combination of CTI PLC rating of 0, UL94 rating of VTM0 at 0.125 mm, and high HDT provides a significant improvement over other compositions, which are particularly well suited for applications in photovoltaic boxes, battery pack insulation films or sheets, or other high heat, thin wall applications.

This disclosure further encompasses the following aspects.

Aspect 1: A thermoplastic composition comprises 5 to 94 weight percent of a poly(phenylene ether)-poly(siloxane) block copolymer reaction product comprising a first poly(phenylene ether) and a poly(phenylene ether)-poly(siloxane) block copolymer; 0.5 to 15 weight percent of a hydrogenated block copolymer of an alkenyl aromatic and a conjugated diene; 0.5 to 10 weight percent of tricalcium phosphate; and 5 to 20 weight percent of an organophosphate ester flame retardant; wherein weight percent is based on the total weight of the composition.

Aspect 2: The composition of aspect 1, further comprising 35 to 75 weight percent of a second poly(phenylene ether) having an intrinsic viscosity of greater than 0.25 deciliters per gram, preferably 0.44 to 0.60 deciliters per gram, more preferably 0.44 to 0.50 deciliters per gram, measured at 25° C. in chloroform using an Ubbelohde viscometer; preferably wherein the second poly(phenylene ether) comprises poly(2,6-dimethyl-1,4-phenylene ether).

Aspect 3: The composition of aspect 1 or 2, wherein a molded sample of the composition exhibits: one or more of: a UL-94 flammability rating of V0, measured using 1.0-millimeter test bars after conditioning at 23° C. for 48 hours and at 70° C. for 168 hours; or a UL-94 flammability rating of V0, measured using 0.75-millimeter test bars after conditioning at 23° C. for 48 hours and at 70° C. for 168 hours; or a UL-94 flammability rating of V0, measured using 0.5-millimeter test bars after conditioning at 23° C. for 48 hours and at 70° C. for 168 hours; or a UL-94 flammability rating of V0, measured using 0.3-millimeter test bars after conditioning at 23° C. for 48 hours and at 70° C. for 168 hours; a UL-94 flammability rating of V0, measured using 0.2-millimeter test ban after conditioning at 23° C. for 48 hours and at 70° C. for 168 hours; a UL-94 flammability rating of VTM0, measured using 0.125-millimeter test bars after conditioning at 23° C. for 48 hours and at 70° C. for 168 hours; and a comparative tracking index of greater than or equal to 500 volts, preferably greater than or equal to 600 volts; and a heat deflection temperature of greater than or equal to 105° C., measured on 3.2 mm thick bars using a load of 1.82 MPa according ASTM D648; and a notched Izod impact strength of greater than or equal to 150 J/m, measured according to ASTM D256.

Aspect 4: The composition of any of aspects 1 to 3, wherein the hydrogenated block copolymer comprises polystyrene-poly(ethylene-butylene)-polystyrene.

Aspect 5: The composition of any of aspects 1 to 4, wherein the organophosphate ester flame retardant comprises resorcinol bis-diphenyl phosphate, bis-phenol A bis-diphenyl phosphate, resorcinol bis(di 2,6-dimethylphenyl phosphate, oligomeric phosphate ester, triphenyl phosphate, or a combination thereof.

Aspect 6: The composition of any of aspects 1 to 5, wherein the composition comprises 0 to 15 weight percent of a homopolystyrene, or a high impact polystyrene.

Aspect 7: The composition of any of aspects 1 to 6, wherein the composition excludes glass fibers.

Aspect 8: The composition of any of aspects 1 to 7, further comprising 0.1 to 10 weight percent of an additive composition.

Aspect 9: The composition of aspect 1, comprising 75 to 89.5 weight percent of the poly(phenylene ether)-poly(siloxane) block copolymer reaction product; 3 to 8 weight percent of the hydrogenated block copolymer of an alkenyl aromatic and a conjugated diene; 0.5 to 5 weight percent of tricalcium phosphate; and 7 to 15 weight percent of the organophosphate ester flame retardant comprising resorcinol bis-diphenyl phosphate, bis-phenol A bis-diphenyl phosphate, or a combination thereof.

Aspect 10: The composition of aspect 1, comprising 5 to 54.5 weight percent of the poly(phenylene ether)-poly(siloxane) block copolymer reaction product; 35 to 70 weight percent of a second poly(phenylene ether); 3 to 10 weight percent of the hydrogenated block copolymer of an alkenyl aromatic and a conjugated diene; 0.5 to 5 weight percent of tricalcium phosphate; and 7 to 15 weight percent of the organophosphate ester flame retardant comprising resorcinol bis-diphenyl phosphate, bis-phenol A bis-diphenyl phosphate, or a combination thereof.

Aspect 11: A method of making the composition of any one or more of aspects 1 to 10; the method comprising melt-mixing the components of the composition.

Aspect 12: An article comprising the composition of any of aspects 1 to 10, preferably wherein the article is an electric vehicle battery module, battery housing, battery case, battery cell frame, battery cell spacers, battery cell retainers, battery pack insulation film or sheet, bus bar holders, terminal covers, an electrical or electronic component, a thermoset circuit breaker, a fuser holder for an electrographic copier, a photovoltaic junction box, photovoltaic connector, an electrical connector, an automotive electrical connector, an electrical relay, a charge coupler, an appliance component, an automotive component, a portable device, a mobile component, or a stationary electrical component.

Aspect 13: The article of aspect 12, wherein the article is a battery pack insulation film or sheet, preferably an electric vehicle battery pack insulation film or sheet.

Aspect 14: A battery pack insulation film or sheet extruded from a composition comprising 5 to 94 weight percent of a poly(phenylene ether)-poly(siloxane) block copolymer reaction product comprising a first poly(phenylene ether) and a poly(phenylene ether)-poly(siloxane) block copolymer; 0.5 to 15 weight percent of a hydrogenated block copolymer of an alkenyl aromatic and a conjugated diene; 0.5 to 10 weight percent of tricalcium phosphate; 5 to 20 weight percent of an organophosphate ester flame retardant; and optionally, 35 to 75 weight percent of a second poly(phenylene ether) having an intrinsic viscosity of greater than 0.25 deciliters per gram, preferably 0.44 to 0.60 deciliters per gram, more preferably 0.44 to 0.50 deciliters per gram, measured at 25° C. in chloroform using an Ubbelohde viscometer; wherein weight percent is based on the total weight of the composition.

Aspect 15: The battery pack insulation film or sheet of aspect 14, wherein the composition comprises 5 to 54.5 weight percent of the poly(phenylene ether)-poly(siloxane) block copolymer reaction product; 35 to 70 weight percent of the second poly(phenylene ether); 3 to 10 weight percent of the hydrogenated block copolymer of an alkenyl aromatic and a conjugated diene; 0.5 to 5 weight percent of tricalcium phosphate; and 7 to 15 weight percent of the organophosphate ester flame retardant comprising resorcinol bis-diphenyl phosphate, bis-phenol A bis-diphenyl phosphate, or a combination thereof; and wherein a molded sample of the composition exhibits: one or more of: a UL-94 flammability rating of V0, measured using 1.0-millimeter test bars after conditioning at 23° C. for 48 hours and at 70° C. for 168 hours; or a UL-94 flammability rating of V0, measured using 0.75-millimeter test bars after conditioning at 23° C. for 48 hours and at 70° C. for 168 hours; or a UL-94 flammability rating of V0, measured using 0.5-millimeter test bars after conditioning at 23° C. for 48 hours and at 70° C. for 168 hours; or a UL-94 flammability rating of V0, measured using 0.3-millimeter test bars after conditioning at 23° C. for 48 hours and at 70° C. for 168 hours; a UL-94 flammability rating of V0, measured using 0.2-millimeter test ban after conditioning at 23° C. for 48 hours and at 70° C. for 168 hours; a UL-94 flammability rating of VTM0, measured using 0.125-millimeter test bars after conditioning at 23° C. for 48 hours and at 70° C. for 168 hours; and a comparative tracking index of greater than or equal to 500 volts, preferably greater than or equal to 600 volts; and a heat deflection temperature of greater than or equal to 105° C., measured on 3.2 mm thick bars using a load of 1.82 MPa according ASTM D648; and a notched Izod impact strength of greater than or equal to 150 J/m, measured according to ASTM D256.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group. —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A thermoplastic composition comprising:
5 to 94 weight percent of a poly(phenylene ether)-poly(siloxane) block copolymer reaction product comprising a first poly(phenylene ether) and a poly(phenylene ether)-poly(siloxane) block copolymer;
0.5 to 15 weight percent of a hydrogenated block copolymer of an alkenyl aromatic and a conjugated diene;
0.5 to 10 weight percent of tricalcium phosphate; and
5 to 20 weight percent of an organophosphate ester flame retardant;
wherein weight percent is based on the total weight of the composition.

2. The composition of claim 1, further comprising 35 to 75 weight percent of a second poly(phenylene ether) having an intrinsic viscosity of greater than 0.25 deciliters per gram, measured at 25° C. in chloroform using an Ubbelohde viscometer.

3. The composition of claim 1, wherein a molded sample of the composition exhibits:
one or more of:
a UL-94 flammability rating of V0, measured using 1.0-millimeter test bars after conditioning at 23° C. for 48 hours and at 70° C. for 168 hours; or
a UL-94 flammability rating of V0, measured using 0.75-millimeter test bars after conditioning at 23° C. for 48 hours and at 70° C. for 168 hours; or
a UL-94 flammability rating of V0, measured using 0.5-millimeter test bars after conditioning at 23° C. for 48 hours and at 70° C. for 168 hours; or
a UL-94 flammability rating of V0, measured using 0.3-millimeter test bars after conditioning at 23° C. for 48 hours and at 70° C. for 168 hours;
a UL-94 flammability rating of V0, measured using 0.2-millimeter test bars after conditioning at 23° C. for 48 hours and at 70° C. for 168 hours;
a UL-94 flammability rating of VTM0, measured using 0.125-millimeter test bars after conditioning at 23° C. for 48 hours and at 70° C. for 168 hours; and
a comparative tracking index of greater than or equal to 500 volts; and
a heat deflection temperature of greater than or equal to 105° C., measured on 3.2 mm thick bars using a load of 1.82 MPa according ASTM D648; and
a notched Izod impact strength of greater than or equal to 150 J/m, measured according to ASTM D256.

4. The composition of claim 1, wherein the hydrogenated block copolymer comprises polystyrene-poly(ethylene-butylene)-polystyrene.

5. The composition of claim 1, wherein the organophosphate ester flame retardant comprises resorcinol bis-diphenyl phosphate, bis-phenol A bis-diphenyl phosphate, resorcinol bis(di 2,6-dimethylphenyl phosphate, oligomeric phosphate ester, triphenyl phosphate, or a combination thereof.

6. The composition of claim 1, wherein the composition comprises 0 to 15 weight percent of a homopolystyrene or a high impact polystyrene.

7. The composition of claim 1, wherein the composition excludes glass fibers.

8. The composition of claim 1, further comprising 0.1 to 10 weight percent of an additive composition.

9. The composition of claim 1, comprising
75 to 89.5 weight percent of the poly(phenylene ether)-poly(siloxane) block copolymer reaction product;
3 to 8 weight percent of the hydrogenated block copolymer of an alkenyl aromatic and a conjugated diene;
0.5 to 5 weight percent of tricalcium phosphate; and
7 to 15 weight percent of the organophosphate ester flame retardant comprising resorcinol bis-diphenyl phosphate, bis-phenol A bis-diphenyl phosphate, or a combination thereof.

10. The composition of claim 1, comprising
5 to 54.5 weight percent of the poly(phenylene ether)-poly(siloxane) block copolymer reaction product;
35 to 70 weight percent of a second poly(phenylene ether);
3 to 10 weight percent of the hydrogenated block copolymer of an alkenyl aromatic and a conjugated diene;
0.5 to 5 weight percent of tricalcium phosphate; and
7 to 15 weight percent of the organophosphate ester flame retardant comprising resorcinol bis-diphenyl phosphate, bis-phenol A bis-diphenyl phosphate, or a combination thereof.

11. A method of making the composition of claim 1; the method comprising melt-mixing the components of the composition.

12. An article comprising the composition of claim 1.

13. The article of claim 12, wherein the article is a battery pack insulation film or sheet.

14. A battery pack insulation film or sheet extruded from a composition comprising
5 to 94 weight percent of a poly(phenylene ether)-poly(siloxane) block copolymer reaction product comprising a first poly(phenylene ether) and a poly(phenylene ether)-poly(siloxane) block copolymer;
0.5 to 15 weight percent of a hydrogenated block copolymer of an alkenyl aromatic and a conjugated diene;
0.5 to 10 weight percent of tricalcium phosphate;
5 to 20 weight percent of an organophosphate ester flame retardant; and
optionally, 35 to 75 weight percent of a second poly(phenylene ether) having an intrinsic viscosity of greater than 0.25 deciliters per gram, measured at 25° C. in chloroform using an Ubbelohde viscometer;
wherein weight percent is based on the total weight of the composition.

15. The battery pack insulation film or sheet of claim 14,
wherein the composition comprises
5 to 54.5 weight percent of the poly(phenylene ether)-poly(siloxane) block copolymer reaction product;
35 to 70 weight percent of the second poly(phenylene ether);
3 to 10 weight percent of the hydrogenated block copolymer of an alkenyl aromatic and a conjugated diene;
0.5 to 5 weight percent of tricalcium phosphate; and
7 to 15 weight percent of the organophosphate ester flame retardant comprising resorcinol bis-diphenyl phosphate, bis-phenol A bis-diphenyl phosphate, or a combination thereof; and
wherein a molded sample of the composition exhibits:
one or more of:
a UL-94 flammability rating of V0, measured using 1.0-millimeter test bars after conditioning at 23° C. for 48 hours and at 70° C. for 168 hours; or
a UL-94 flammability rating of V0, measured using 0.75-millimeter test bars after conditioning at 23° C. for 48 hours and at 70° C. for 168 hours; or
a UL-94 flammability rating of V0, measured using 0.5-millimeter test bars after conditioning at 23° C. for 48 hours and at 70° C. for 168 hours; or
a UL-94 flammability rating of V0, measured using 0.3-millimeter test bars after conditioning at 23° C. for 48 hours and at 70° C. for 168 hours;
a UL-94 flammability rating of V0, measured using 0.2-millimeter test bars after conditioning at 23° C. for 48 hours and at 70° C. for 168 hours;
a UL-94 flammability rating of VTM0, measured using 0.125-millimeter test bars after conditioning at 23° C. for 48 hours and at 70° C. for 168 hours; and
a comparative tracking index of greater than or equal to 500 volts; and
a heat deflection temperature of greater than or equal to 105° C., measured on 3.2 mm thick bars using a load of 1.82 MPa according ASTM D648; and
a notched Izod impact strength of greater than or equal to 150 J/m, measured according to ASTM D256.
